(19) United States
(12) Patent Application Publication
(10) Pub. No.: US 2013/0077623 A1
(43) Pub. Date: Mar. 28, 2013

(54) MULTI-LANE BASED ETHERNET APPARATUS AND LANE OPERATING METHOD FOR DYNAMIC LANE OPERATION

(71) Applicant: Kyeong Eun HAN, Daejeon (KR)

(72) Inventor: Kyeong Eun HAN, Daejeon (KR)

(73) Assignee: Electronics and Telecommunications Research Institute, Daejeon (KR)

(21) Appl. No.: 13/565,045

(22) Filed: Aug. 2, 2012

(30) Foreign Application Priority Data
Sep. 26, 2011 (KR) 10-2011-0096892

(51) Int. Cl. H04L 12/56

(52) U.S. Cl. 370/389

(57) ABSTRACT

Disclosed is an Ethernet apparatus having a plurality of lanes according to the present invention, including: a transmission lane identifying unit to identify a physical transmission lane according to a data transmission order by activating a transmitter, and by verifying data to be transmitted through the activated transmitter; and a transmission lane adjusting unit to adjust the physical transmission lane using information about the number of operable lanes and to transmit data through the adjusted physical transmission lane when the physical transmission lane is identified by the transmission lane identifying unit.

### CROSS-REFERENCE TO RELATED APPLICATIONS

This application claims priority to and the benefit of Korean Patent Application No. 10-2011-0096892 filed in the Korean Intellectual Property Office on Sep. 26, 2011, the entire contents of which are incorporated herein by reference.

### TECHNICAL FIELD

The present invention relates to an Ethernet apparatus for dynamically operating a lane in multi-lane based Ethernet and a lane operating method of the Ethernet apparatus.

### BACKGROUND ART

Currently, power consumption has significantly increased according to an increase in server and data amount. Accordingly, interest on a technology capable of achieving energy saving and low power consumption has increased. Research and development and standardization have been ongoing in various fields. In the case of Ethernet, energy efficient Ethernet (EEE) about copper based 10G Ethernet was completed in Institute of Electrical and Electronics Engineers (IEEE) 802.3az in 2010. Currently, commercial products for energy saving type Ethernet switch in which 802.3az standard is reflected have been released.

On the other hand, a standard for 40G/100G high-speed Ethernet has been completed in IEEE 802.3ba, but does not include an energy saving technology. As a network speed becomes fast, a power consumption amount of a communication apparatus significantly increases. Considering the above aspect, an energy saving technology for high-speed Ethernet is required. In IEEE 802.3ba, a multi-lane structure is adopted for 40G/100G high-speed Ethernet. In the multi-lane structure, a single high-speed transmission link is configured using a plurality of lanes having a low transmission rate.

In the case of multi-lane based Ethernet, power saving effect may be obtained by dynamically operating a lane based on a traffic state and by deactivating a physical lane or a transmitter/receiver not used.

To dynamically operate a lane based on a network state, lane adjustment is required between a transmission side and a reception side. A function of adjusting a transmission rate and distributing traffic needs to be provided so that traffic may be transmitted through a using lane. Support of a physical layer is required to make it possible to transmit and receive lossless data based on a change in the number of lanes being used.

### SUMMARY OF THE INVENTION

The present invention has been made in an effort to provide a lane identification and lane adjustment technology for efficiently transmitting data through a modified lane while dynamically operating a lane based on a network state.

The present invention also provides an Ethernet apparatus for efficiently transmitting and receiving data while dynamically operating a lane in multi-lane based Ethernet, and a lane operating method of the Ethernet apparatus.

An exemplary embodiment of the present invention provides a multi-lane based Ethernet apparatus, including: a transmission lane identifying unit to identify a physical transmission lane according to a data transmission order by activating a transmitter, and by verifying data to be transmitted through the activated transmitter; and a transmission lane adjusting unit to adjust the physical transmission lane using information about the number of operable lanes, and to transmit data through the adjusted physical transmission lane when the physical transmission lane is identified by the transmission lane identifying unit.

Another exemplary embodiment of the present invention provides a multi-lane based Ethernet apparatus, including: a transmission lane identification response unit to generate a response message by extracting or processing lane identification information that is received through a plurality of receivers; and a reception lane adjusting unit to change the number of lanes of a reception lane by obtaining modified lane information, and to receive lossless data through the reception lane in which the number of lanes is changed.

Still another exemplary embodiment of the present invention provides a multi-lane based Ethernet apparatus, including: a transmission lane identifying unit to identify a corresponding relationship between a data transmission order and a physical transmission lane; a transmission lane adjusting unit to adjust the physical transmission lane based on information about the number of operable lanes; and a transmission rate control unit to insert an idle block into a data position corresponding to a deactivated lane according to adjustment of the physical transmission lane using the identified corresponding relationship.

Yet another exemplary embodiment of the present invention provides a multi-lane based Ethernet apparatus, including: a deactivated lane recognizing unit to recognize a deactivated lane in a physical transmission lane; a lane alignment unit to align a plurality of lanes by inserting an idle block into the deactivated lane; and a decoding unit to decode a data block and the idle block through the aligned lanes.

According to exemplary embodiments of the present invention, it is possible to dynamically operate a lane through lane identification, lane adjustment, and adjustment of a data transmission rate in a multi-lane based high-seed Ethernet. That is, it is possible to minimize additional buffering and processing delay without data loss by adjusting a data transmission rate based on lane adjustment information. It is also possible to decrease an energy consumption amount by dynamically operating a lane through a lane identification and adjustment mechanism.

It is also possible to efficiently transmit and receive data, and to effectively control a transmission rate without data loss while dynamically operating a lane in multi-lane based Ethernet.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a block diagram illustrating a hierarchical structure of a multi-lane based Ethernet apparatus according to an exemplary embodiment of the present invention.

FIG. 2 is a block diagram illustrating a configuration of an Ethernet apparatus of a transmission side according to an exemplary embodiment of the present invention.

FIG. 3 is a block diagram illustrating a configuration of an Ethernet apparatus of a reception side according to an exemplary embodiment of the present invention.

FIG. 4 is a flowchart illustrating a lane identifying method of an Ethernet apparatus according to an exemplary embodiment of the present invention.

FIGS. 5A and 5B are diagrams illustrating a data structure of a lane identification message according to various exemplary embodiments of the present invention.

FIG. 6 is a flowchart illustrating a lane adjusting method of an Ethernet apparatus according to an exemplary embodiment of the present invention.

FIGS. 7A and 7B are diagrams illustrating a data structure of a lane adjustment message according to various exemplary embodiments of the present invention.

FIGS. 8A and 8B are diagrams illustrating a data structure of a lane operation message according to various exemplary embodiments of the present invention.

FIG. 9 is a block diagram illustrating a hierarchical structure of a multi-lane based Ethernet apparatus according to another exemplary embodiment of the present invention.

FIG. 10 is a block diagram illustrating a configuration of a reconciliation sublayer (RS) of an Ethernet apparatus of a transmission side according to another exemplary embodiment of the present invention.

FIG. 11 is a block diagram illustrating a configuration of an RS of an Ethernet apparatus of a reception side according to another exemplary embodiment of the present invention.

FIGS. 12A and 12B are reference diagrams to describe an operation of a transmission rate control unit.

FIG. 13 is a block diagram illustrating a configuration of a physical coding sublayer (PCS) of an Ethernet apparatus of a transmission side according to another exemplary embodiment of the present invention.

FIG. 14 is a block diagram illustrating a configuration of a physical medium attachment sublayer (PMA) of an Ethernet apparatus of a reception side according to another exemplary embodiment of the present invention.

FIG. 15 is a block diagram illustrating a configuration of a PCS of an Ethernet apparatus of a reception side according to another exemplary embodiment of the present invention.

FIG. 16 is a block diagram illustrating a configuration of physical medium dependent sublayers (PMDs) of Ethernet apparatuses of a transmission side and a reception side according to another exemplary embodiment of the present invention.

FIG. 17 is a flowchart illustrating a lane operating method of an Ethernet apparatus of a transmission side according to another exemplary embodiment of the present invention.

FIG. 18 is a flowchart illustrating a lane operating method of an Ethernet apparatus of a reception side according to another exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

When assigning reference numerals to constituent elements of each drawing, like reference numerals refer to like elements throughout the specification and thus, a repeated description will be omitted here. When it is determined the detailed description related to a related known function or configuration may make the purpose of the present invention unnecessarily ambiguous in describing the present invention, the detailed description will be omitted here.

The present invention relates to a technology for dynamically operating a lane based on a network state in multi-lane based high-speed Ethernet. To dynamically operate a lane, an electrical lane, an optical lane, or a transmitter (Tx) that is a physical lane through which data is substantially transmitted needs to be known. Data needs to be transmitted and received without data loss by adjusting a transmission lane to be used for transmission and reception. The present invention proposes a lane adjustment technology for lane identification according to transmission data and data transmission in a multi-lane based Ethernet apparatus. The present invention may be applied to all the multi-lane based Ethernet networks as well as high-speed Ethernet including 40G and 100G Ethernet. Hereinafter, exemplary embodiments of the present invention will be described in detail with reference to the accompanying drawings.

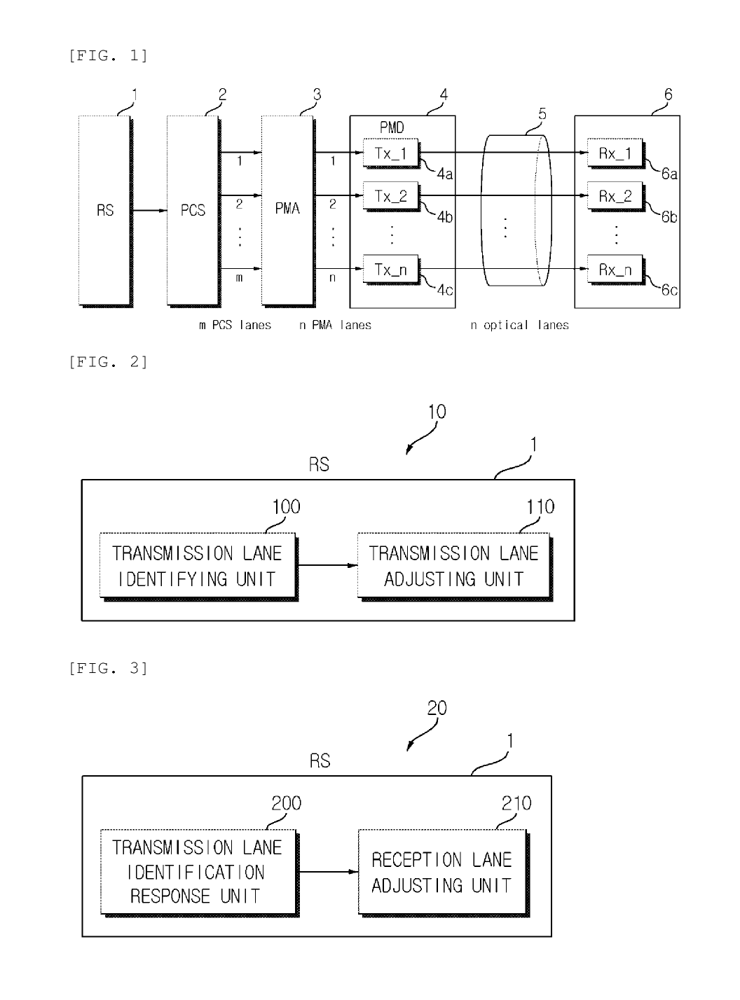

FIG. 1 is a block diagram illustrating a hierarchical structure of a multi-lane based Ethernet apparatus according to an exemplary embodiment of the present invention.

Referring to FIG. 1, the hierarchical structure of the Ethernet apparatus includes a reconciliation sublayer (RS) 1, a physical coding sublayer (PCS) 2, a physical medium attachment sublayer (PMA) 3, and a physical medium dependent sublayer (PMD) 4.

A medium access control (MAC) layer may be present as an upper layer of the RS 1. The RS 1 converts a signal so that the MAC layer may perform communication regardless of a type of a physical layer. For example, the RS 1 converts received data to a PLS primitive to be recognizable by the MAC layer, or converts, to be in a transmittable form based on a type of a link, data that is transmitted from the MAC layer. The PCS 2 generates a code block for data transmission or decodes a received code block. For example, the PCS 2 generates a code block according to a 64B/66B block coding scheme, or decodes a received code block. The PMA 3 transfers, to a physical medium, the code block that is received from the PCS 2, or transfers, to the PCS 2, data that is received from the link. The PMD 4 connects the physical medium to the PCS 2 together with the PMA 3. The PMD 4 defines physical layer signaling for various physical media.

The Ethernet apparatus of the present invention has a plurality of lanes for high-speed data transmission. Referring to FIG. 1, the multi-lane based Ethernet apparatus has m PCS lanes, n PMA lanes, and n optical lanes for the respective layers. Here, the PCS lane is a virtual lane and the PMA lane is an electrical lane. Data and control blocks transmitted from the RS 1 are distributed to a plurality of PCS lanes in the PCS 2 and thereby are transferred to the PMA 3. The PMA 3 receives m virtual lanes as an input to output n electrical lanes. Here, a value of m may be equal to a value of n. For example, in the case of 40G Ethernet, m and n=4 and thus, are equal to each other. However, 100G Ethernet specifies that m=20 and n=10 or n=4.

n data blocks that are output from the PMA 3 are input into the PMD 4, experience electric-to-optic conversion of transmitters 4a, 4b, . . . , 4n, and are transmitted to receivers 6a, 6b, . . . , 6n of a reception side 6 through an optical link 5 including n optical lanes, respectively. As another example, another transmission medium except for “optic” may be used for a transmission link. A channel configured to be in parallel within a transmission medium may be understood to be identical to an optical lane. A PCS virtual lane, a PMA electrical lane, and a PMD optical lane have a corresponding relationship based on a configuration method. A path between lanes to which a data block is transferred is consistent. That is, a data block distributed to a random PCS virtual lane number x is transferred through a predetermined PMD optical lane number y at all times.

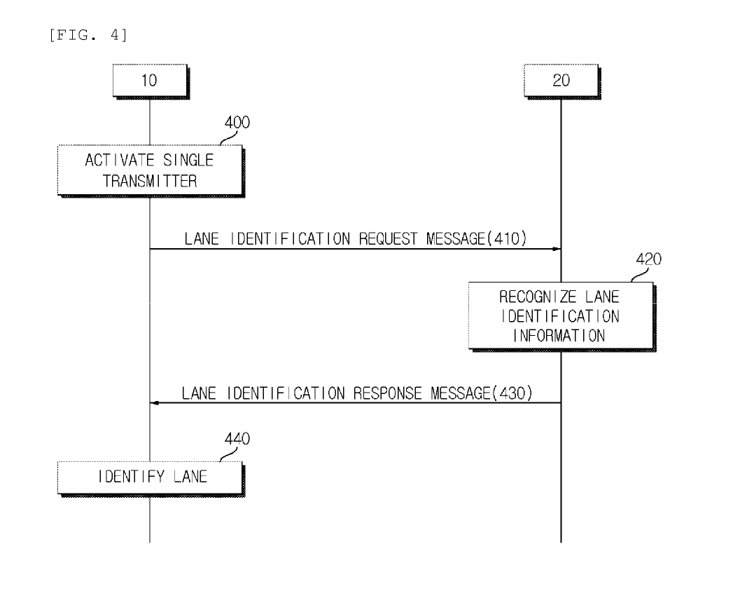

FIG. 2 is a block diagram illustrating a configuration of an Ethernet apparatus of a transmission side according to an exemplary embodiment of the present invention.

Referring to FIGS. 1 and 2, an Ethernet apparatus 10 of a transmission side includes a transmission lane identifying unit 100 and a transmission lane adjusting unit 110. The transmission lane identifying unit 100 and the transmission lane adjusting unit 110 may be formed within the RS 1.

The transmission lane adjusting unit 110 adjusts an actual physical transmission lane using information about the number of operable lanes, and controls a transmission rate of transmission data through the adjusted physical transmission lane. For the above operation, the transmission lane identifying unit 100 needs to be aware of a transmitter, which is an actual physical transmission path corresponding to a data transmission order, and an optical lane path, so that transmission data may be accurately transmitted to an activated lane.

According to an exemplary embodiment, a path between lanes to which a data block is transferred is consistent and thus, the transmission lane identifying unit 100 activates a single transmitter among a plurality of transmitters. That is, the transmission lane identifying unit 100 transmits a data block to a reception side by activating only a single optical lane, and identifies a physical lane or a physical path corresponding to a transmission order by verifying a lane identification response message from the reception side. Here, the transmission lane identifying unit 100 may generate a lane identification request message to be greater than or equal to the number of virtual lanes, and may transmit the lane identification request message to the reception side through the activated transmitter. The lane identification request message includes lane identification information indicating an order in which data is distributed and thereby is transmitted.

According to an exemplary embodiment, when information about the changed number of operable lanes is received from an upper layer, the transmission lane adjusting unit 110 transmits, to the reception side through a currently available physical transmission lane, a lane adjustment request message including lane information for lane modification. When a lane adjustment response message is received from the reception side, the transmission lane adjusting unit 110 changes the number of lanes of the physical transmission lane to be used for data transmission, and transmits lossless data through the physical transmission lane in which the number of lanes is changed.

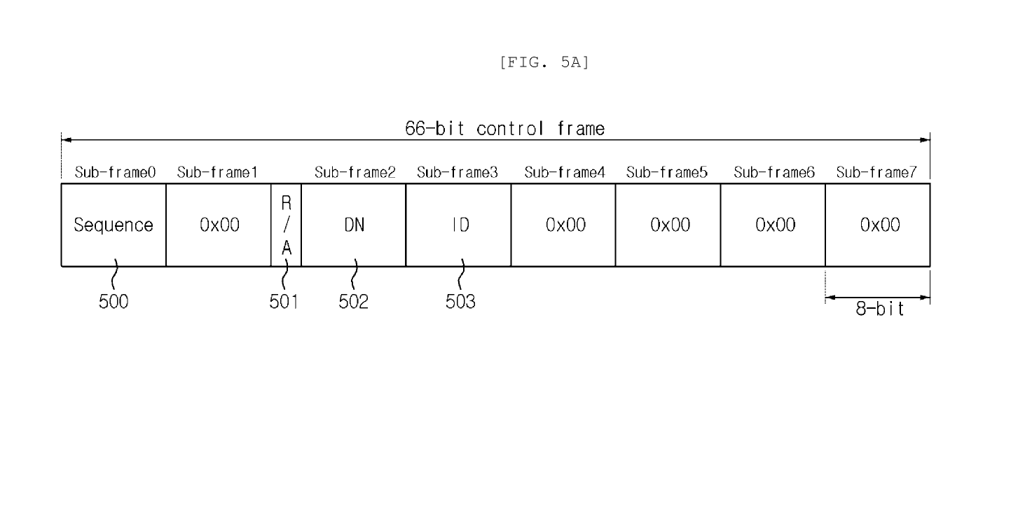

FIG. 3 is a block diagram illustrating a configuration of an Ethernet apparatus of a reception side according to an exemplary embodiment of the present invention.

Referring to FIGS. 1 and 3, an Ethernet apparatus 20 of a reception side includes a transmission lane identification response unit 200 and a reception lane adjusting unit 210. The transmission lane identification response unit 200 and the reception lane adjusting unit 210 may be formed within the RS 1.

The transmission lane identification response unit 200 extracts or processes lane identification information received through the plurality of receivers 6 and thereby transmits the extracted or processed lane identification information to a transmission side using a lane identification response message. According to an exemplary embodiment, the transmission lane identification response unit 200 receives, from the transmission side through the plurality of receivers 6, a lane identification request message that includes lane identification information indicating an order in which data is distributed and thereby is transmitted. The transmission lane identification response unit 200 extracts or processes the lane identification information from the received lane identification request message, and transmits, to the transmission side, a lane identification response message including the lane identification information.

The reception lane adjusting unit 210 changes the number of lanes of a reception lane by obtaining modified lane information, and receives lossless data through the reception lane in which the number of lanes is changed. According to an exemplary embodiment, the reception lane adjusting unit 210 receives, from the transmission side, a lane adjustment request message including information about the changed number of lanes and changes the number of lanes to be used for data reception. The reception lane adjusting unit 210 transmits, to the transmission side, a lane adjustment response message indicating that changing of the number of lanes is completed.

FIG. 4 is a flowchart illustrating a lane identifying method of an Ethernet apparatus according to an exemplary embodiment of the present invention.

In FIG. 4, a reference numeral 10 indicates an Ethernet apparatus of a transmission side and a reference numeral 20 indicates an Ethernet apparatus of a reception side. The Ethernet apparatus 10 of the transmission side and the Ethernet apparatus 20 of the reception side may identify a physical lane in an RS.

Referring to FIG. 4, the Ethernet apparatus 10 of the transmission side activates only a single transmitter among a plurality of transmitters and deactivates remaining transmitters (400). Next, the Ethernet apparatus 10 of the transmission side consecutively transmits, to the Ethernet apparatus 20 of the reception side, a lane identification request message including lane identification information (410). Here, the lane identification information indicates an order in which data is distributed and transmitted in the RS.

The Ethernet apparatus 10 of the transmission side may generate and thereby transmit the number of lane identification request messages corresponding to the number of PCS lanes. For example, in the case of 40G Ethernet, four PCS lanes are supported and thus, the Ethernet apparatus 10 of the transmission side writes numbers 1 to 4 in lane identification request messages and thereby sequentially transmits the lane identification request messages 1 to 4. In the case of 100G Ethernet, twenty PCS lanes are supported and thus, the Ethernet apparatus 10 of the transmission side writes numbers 1 to 20 in lane identification request messages and thereby sequentially transmits the lane identification request messages 1 to 20. However, it is only an example of the present invention and thus, the number of transmitters to be activated and the number of lane identification request messages to be transmitted may vary based on configuration methods.

The Ethernet apparatus 20 of the reception side receives and processes the lane identification request messages including the lane identification information through receivers that are configured in parallel, and processes the lane identification information (420). The Ethernet apparatus 20 of the reception side generates a lane identification response message including the corresponding lane identification information and consecutively transmits the lane identification response message to the Ethernet apparatus 10 of the transmission side (430).

A process for processing lane identification information (420) and transmitting the lane identification response message (430) may vary based on transmission of the lane identification request message (410). According to an exemplary embodiment, the Ethernet apparatus 10 of the transmission side employs a bitmapping scheme when writing a data transmission order in the lane identification request message. That is, each bit corresponds to a transmission order. For example, in the case of a first transmission block, a first bit is set to 1 (or 0). In the case of a second transmission block, a second bit is set to 1 (or 0). Next, the Ethernet apparatus 20 of the reception side processes bit information (using AND, OR, EX-OR, operation, mask, and the like) (420), and transmits, to the Ethernet apparatus 10 of the transmission side, the lane identification response message including the lane identification information (430).

As another exemplary embodiment, the Ethernet apparatus 10 of the transmission side writes a data block transmission order in a predetermined field of the lane identification request message and thereby transmits the lane identification request message. For example, orders are expressed such as a first transmission block as 00001, a second transmission block as 00010, and a third transmission block as 00011. Here, logarithm and the number of bits to express an order may be diversified based on a configuration method. The Ethernet apparatus 20 of the reception side that receives the lane identification request message transmits the received lane identification information to the Ethernet apparatus 10 of the transmission side through the lane identification response message without particular processing of the lane identification information in lane identification information processing operation 420 (430).

Meanwhile, the Ethernet apparatus 10 of the transmission side activates all the transmitters that are deactivated, that is, optical lanes. The Ethernet apparatus 10 of the transmission side receives the lane identification response message from the Ethernet apparatus 20 of the reception side (430). Next, the Ethernet apparatus 10 of the transmission side makes a physical lane or path correspond to a data transmission order based on the lane identification information included in the received lane identification response message (440).

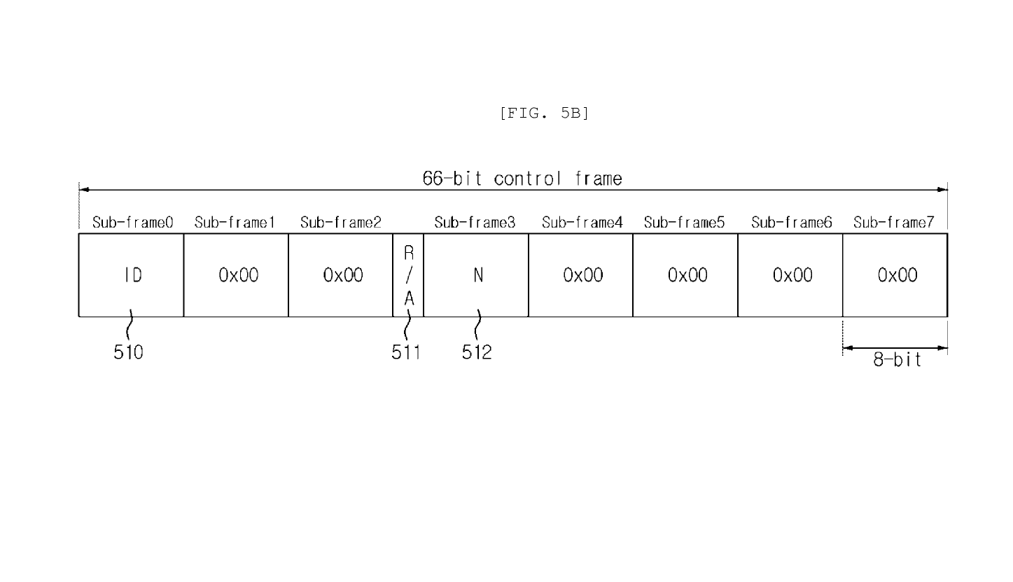

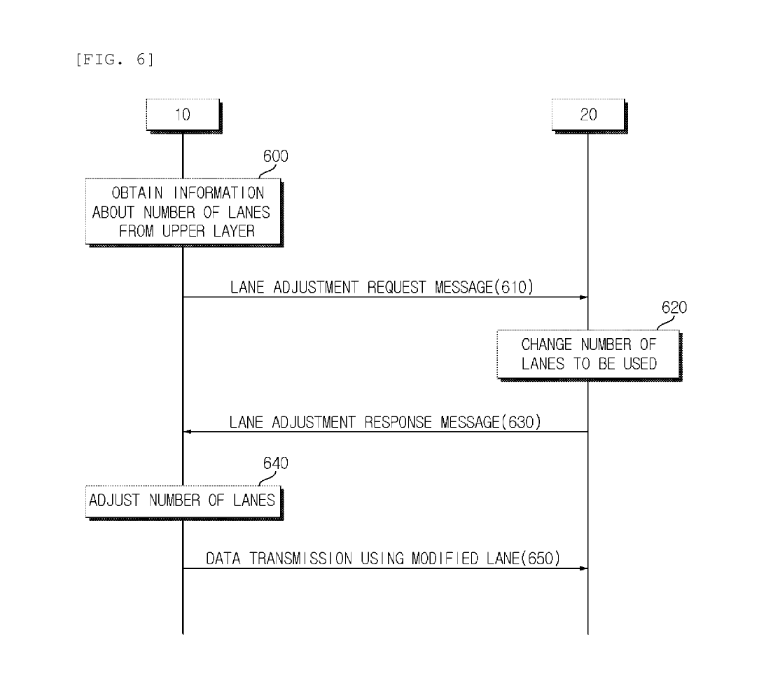

FIGS. 5A and 5B are diagrams illustrating a data structure of a lane identification message according to various exemplary embodiments of the present invention.

Referring to FIGS. 5A and 5B, a lane identification message including a lane identification request message and a lane identification response message expresses a message type and identification information using a 66-bit frame. The lane identification message is generated, processed, and transmitted in an RS.

According to an exemplary embodiment, as shown in FIG. 5A, the lane identification messages eight sub-frames, each having a size of eight bits, and has a sequence ordered set frame format. Sub-frame0 500 indicates a sequence value (for example, 0x9C in 40G/100G Ethernet). Sub-frame2 includes an R/A field 501 of a single bit and a distribution number (DN) field 502 of seven bits. The R/A field 501 identifies whether a corresponding message is the lane identification request message or the lane identification response message. The DN field 502 is lane identification information and indicates an order in which data is distributed and thereby is transmitted in an RS. Sub-frame3 indicates an ID field 503 and the lane identification message may be expressed to be a value of at least 0x04. As an exemplary embodiment, when the ID field 503 has a value of 0x04, the lane identification message is recognized and remaining sub-frames have a value of 0x00.

According to another exemplary embodiment, as shown in FIG. 5B, the lane identification message is configured by defining a 66-bit control frame. Sub-frame0 is an ID field 510 and indicates a type of a control message. For example, in the case of 40G/100G Ethernet, ID is expressed such as Idle as 0x07 and Start as 0xFB. As ID that indicates the lane identification message, 0x9D may be defined. Sub-frame3 includes an R/A field 511 of a single bit and an N field 512 of seven bits. The R/A field 511 indicates whether a corresponding message is the lane identification request message or the lane identification response message. The N field 512 is lane identification information and indicates an order in which data is distributed and thereby is transmitted in the RS. Meanwhile, the aforementioned exemplary embodiment is only an example and thus, the number of bits and an information transfer position may be diversified based on a configuration method. The lane identification message generated in the RS is transmitted to a PCS together with a control signal (TXC=1).

FIG. 6 is a flowchart illustrating a lane adjusting method of an Ethernet apparatus according to an exemplary embodiment of the present invention.

In FIG. 6, a reference numeral 10 indicates an Ethernet apparatus of a transmission side and a reference numeral 20 indicates an Ethernet apparatus of a reception side. The Ethernet apparatus 10 of the transmission side and the Ethernet apparatus 20 of the reception side may perform lane adjustment in an RS.

Referring to FIG. 6, it is possible to decrease power consumption by dynamically operating a lane based on a network state or a traffic state in an upper layer of the RS. The RS adjusts a transmission lane of the transmission side and a transmission lane of the reception side based on information about the number of lanes determined in the upper layer.

Initially, the Ethernet apparatus 10 of the transmission side obtains information about the number of lanes from the upper layer through the RS (600). The Ethernet apparatus 10 of the transmission side transmits a lane adjustment request message to the Ethernet apparatus 20 of the reception side through all the physical lanes that are being currently used (610). The lane adjustment request message includes lane adjustment information including the number of lanes to be increased or decreased or the number of lanes to be used for data transmission.

When the lane adjustment request message including the lane adjustment information for lane modification is received from the Ethernet apparatus 10 of the transmission side (610), the Ethernet apparatus 20 of the reception side updates the number of lanes to be used for reception and informs a physical layer about the lane adjustment information (620). The physical layer receives data in a power saving mode. Next, the Ethernet apparatus 20 of the reception side informs the Ethernet apparatus 10 of the transmission side that the lane adjustment is completed using a lane adjustment response message (630).

When the lane adjustment response message is received from the Ethernet apparatus 20 of the reception side, the Ethernet apparatus 10 of the transmission side (630) adjusts the number of lanes of the physical lane to be used for data transmission (640) and transmits data to the Ethernet apparatus 20 of the reception side through the physical lane in which the number of lanes is adjusted (650).

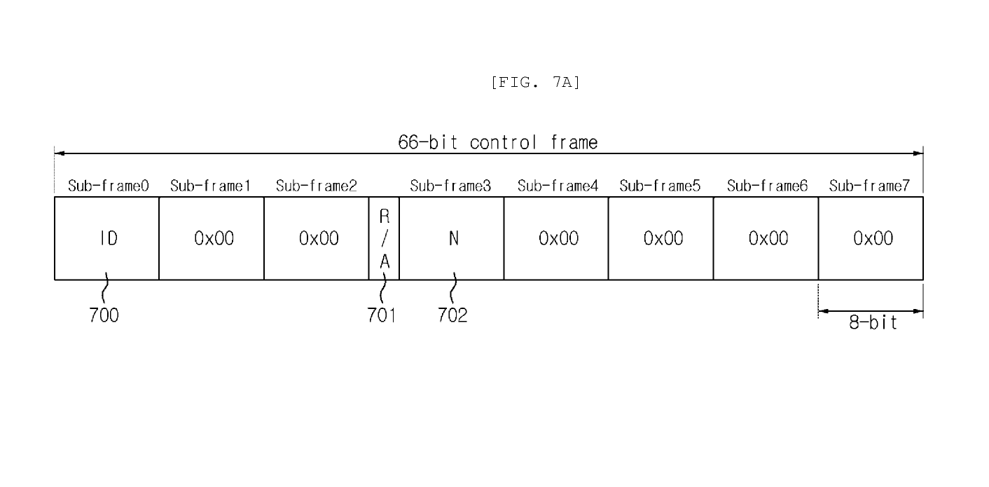

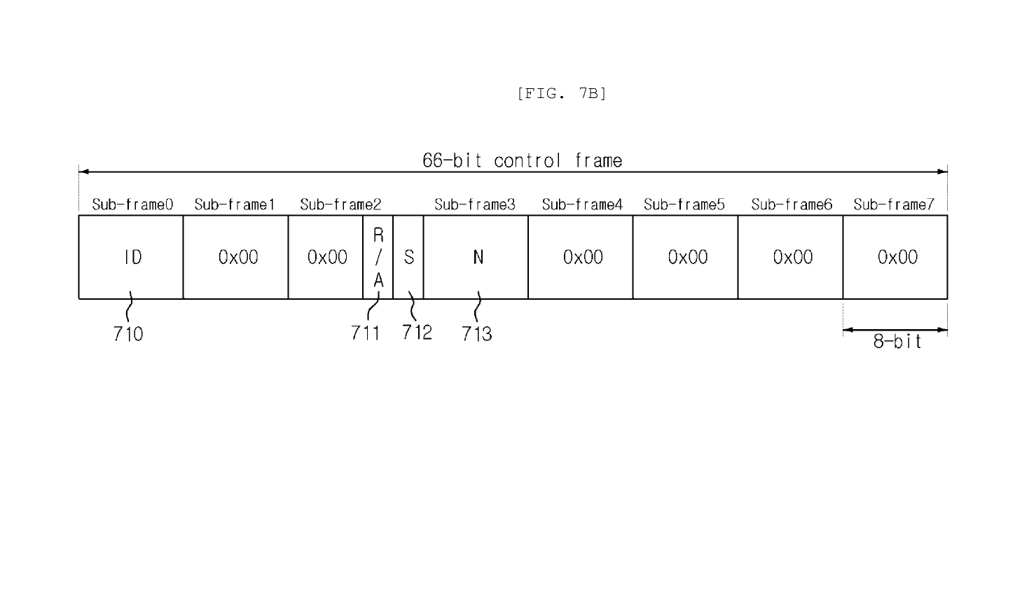

FIGS. 7A and 7B are diagrams illustrating a data structure of a lane adjustment message according to various exemplary embodiments of the present invention.

The lane adjustment message may be used by defining a 66-bit control frame. FIG. 7A illustrates an exemplary embodiment in which lane adjustment information includes the number of lanes to be used for data transmission, and FIG. 7B illustrates an exemplary embodiment in which the lane adjustment information includes the increased or decreased number of lanes.

According to an exemplary embodiment, as shown in FIG. 7A, sub-frame0 is an ID field 700 and indicates a type of a control message. For example, 0x9E may be defined as ID that indicates a lane adjustment message. Sub-frame3 includes an R/A field 701 of a single bit and an N field 702 of seven bits. The R/A field 701 identifies whether a corresponding message is a lane adjustment request message or a lane adjustment response message. The N field 702 includes information about the number of lanes to be used for data transmission.

According to another exemplary embodiment, as shown in FIG. 7B, sub-frame0 is an ID field 710 and indicates a type of a control message. Sub-frame2 includes an R/A field 711 and an S field 712. The R/A field 711 identifies whether a corresponding message is the lane adjustment request message or the lane adjustment response message. The S field 712 includes information about an increase or a decrease in the number of lanes. In the exemplary embodiment, the R/A field 711 includes three bits and the S field 712 includes a single field. To express the changed number of lanes, sub-frame 3 is used as an N field 706. Meanwhile, the aforementioned exemplary embodiment is only an example to easily understand the present invention and thus, the number of bits, a corresponding field, and information transfer position may be diversified based on a configuration method. The lane identification message generated in the RS is transmitted to a PCS together with a control signal (TXC=1).

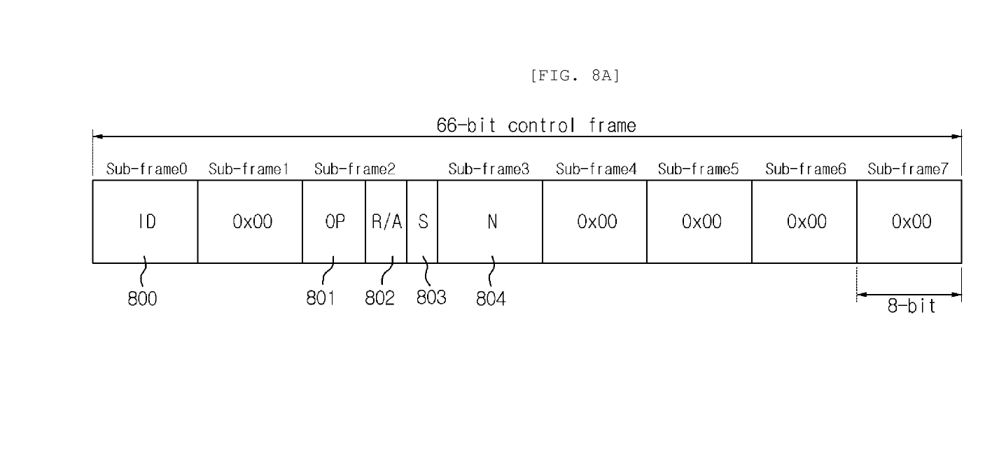

FIGS. 8A and 8B are diagrams illustrating a data structure of a lane operation message according to various exemplary embodiments of the present invention.

Referring to FIGS. 8A and 8B, the lane operation message may be used by defining a common frame about lane operation. The lane operation message aims to transfer information for dynamic operation of a lane, such as a lane identification message, a lane adjustment message, a message for a lane error, and the like.

As shown in FIGS. 8A and 8B, ID fields 800 and 810 of sub-frame0 of the lane operation message relate to identifying a type of a control message and indicate the lane operation message. OP fields 801 and 811 are to identify a type of the lane operation message and define the respective messages associated with lane identification, lane adjustment, and the lane error. R/A fields 802 and 812 identify whether a corresponding message is a request message or a response message. S fields 803 and 813 are used as a field to indicate an increase or a decrease in the number of lanes. The S fields 803 and 813 are not necessarily used and may not be used based on lane information.

In FIG. 8A, an N field 804 includes an identification number or information about the number of lanes based on the type of the lane operation message identified by the OP field 801. In FIG. 8B, a lane information field 814 may include an identification number, information about the number of lanes, information about a state of each lane, and the like, based on the type of the message identified by the OP field 811. Meanwhile, the aforementioned exemplary embodiment is only an example to easily understand the present invention and thus, the number of bits, a corresponding field, and an information transfer position may be diversified based on a configuration method.

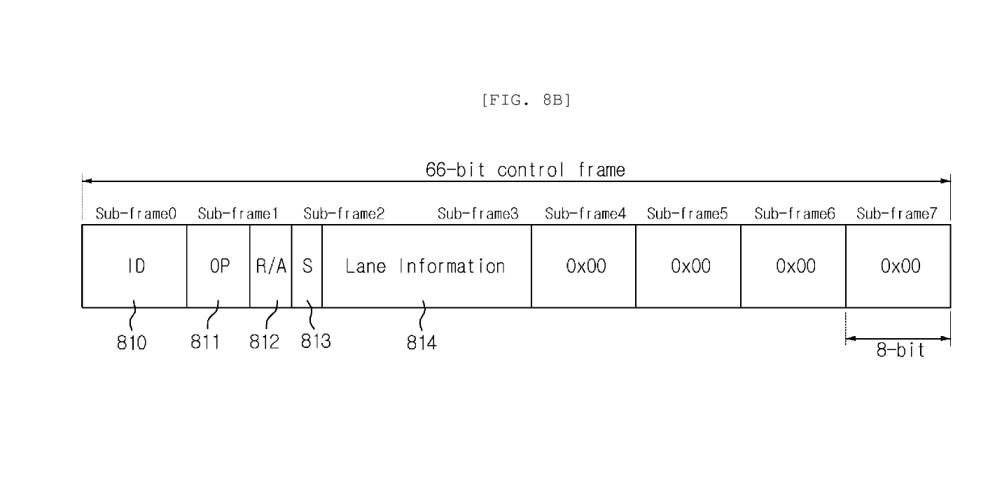

FIG. 9 is a block diagram illustrating a hierarchical structure of a multi-lane based Ethernet apparatus according to another exemplary embodiment of the present invention.

Referring to FIG. 9, the hierarchical structure of the Ethernet apparatus includes RSs 30 and 90, PCSs 40 and 80, PMAs 50 and 70, and PMDs 60 and 65.

A MAC layer may be present as an upper layer of each of the RSs 30 and 90. Each of the RSs 30 and 90 converts a signal so that the MAC layer may perform communication regardless of a type of a physical layer. For example, each of the RSs 30 and 90 converts received data to a PLS primitive to be recognizable by the MAC layer, or converts, to a transmittable form based on a type of a link, data that is transferred from the MAC layer. Each of the PCSs 40 and 80 generates a code block for data transmission and decodes a received code block. For example, each of the PCSs 40 and 80 generates a code block according to a 64B/66B block coding scheme or decodes a received code book. The PMAs 50 and 70 transfer, to a physical medium, the code block that is received from the PCS 40, or transfer, to the PCS 80, data that is received from the link. The PMDs 60 and 65 connect the physical medium to the PCSs 40 and 80 together with the PMAs 50 and 70, respectively. The PMDs 60 and 65 define physical layer signaling for various physical media.

An Ethernet apparatus according to an exemplary embodiment of the present invention has a plurality of lanes for high-speed data transmission. Referring to FIG. 9, the multi-lane based Ethernet apparatus has m PCS lanes, n PMA lanes, and n optical lanes. Here, the PCS lane is a virtual lane and the PMA lane is an electrical lane. Data and control blocks transmitted from the RS 30 of the transmission side are distributed to a plurality of PCS lanes in the PCS 40 and thereby are transferred to the PMA 50. The PMA 50 receives m virtual lanes as an input to output n electrical lanes. Here, a value of m may be equal to a value of n, or may be different from a value of n. For example, in the case of 40G Ethernet, m and n=4. However, 100G Ethernet specifies that m=20 and n=10 or n=4.

n data blocks that are output from the PMA 50 are input to the PMD 60, experience electric-to-optic conversion of transmitters (Tx_{—}1, Tx_{—}2, . . . , Tx_n), and are transmitted to receivers (Rx_{—}1, Rx_{—}2, . . . , Rx_n) of the reception side through an optical link including n optical lanes, respectively. As another example, another transmission medium except for “optic” may be used for a transmission link. A channel configured to be in parallel within a transmission medium may be understood to be identical to an optical lane. A PCS virtual lane, a PMA electrical lane, and a PMD optical lane have a corresponding relationship based on a configuration method. A path between lanes to which a data block is transferred is consistent. That is, a data block distributed to a random PCS virtual lane number x is transferred through a predetermined PMD optical lane number y at all times. The transmitted data block is converted to an electrical signal in the PMD 65 and is input to the PMA 70. The PMA 70 receives n electrical lanes as an input to output m virtual lanes. The PCS 80 performs descrambling and decoding with respect to a signal input from the PMA 70, and transfers the descrambled and decoded signal to the RS 90.

An exemplary embodiment of the present invention proposes functions of the RSs 30 and 90 and a physical (PHY) layer to dynamically operate a lane based on a traffic state and a network state. Each of the RSs 30 and 90 functions to adjust a physical lane (an electrical lane, an optical lane, or a transceiver) used to substantially transmit data based on information about the number of operable lanes that is determined in an upper layer and accordingly, to control a transmission rate of data to be transmitted. Each of the RSs 30 and 90 needs to be aware of a corresponding relationship between a data transmission order in the RSs 30 and 90 and a physical lane used to substantially transmit data, so that the data may be accurately transmitted to an activated lane. In response to a request of the upper layer, the number of physical lanes for transmission needs to be dynamically adjusted. For the above operation, the RS 30 of the transmission side may perform identification of the physical lane and dynamic lane adjustment by exchanging a message with the RS 90 of the reception side. The RSs 30 and 90 and all the sub-layers (PCS, PMA, and PMD) of the PHY layer provide a low power mode as an option and operate in the low power mode when using a portion of the lanes. The RSs 30 and 90 and the sub-layers of the PHY layer provide a function of switching off an electrical lane corresponding to a deactivated optical lane and a device such as an input/output (I/O) port, an optical device, and the like present in a transmission and reception path of a deactivated lane.

FIG. 10 is a block diagram illustrating a configuration of an RS 30 of an Ethernet apparatus of a transmission side according to another exemplary embodiment of the present invention. The RS 30 includes a transmission lane identifying unit 31, a transmission lane adjusting unit 32, and a transmission rate control unit 33.

The transmission lane adjusting unit 32 adjusts an actual physical transmission lane based on information about the number of operable lanes, and the transmission rate control unit 33 controls a transmission rate of transmission data through the adjusted physical transmission lane. For the above operation, the transmission lane identifying unit 31 needs to be aware of a transmitter, which is an actual physical transmission path corresponding to a data transmission order, and an optical lane path, so that transmission data may be accurately transmitted to an activated lane.

According to an exemplary embodiment, a path between lanes to which data blocks are transferred is consistent, and the transmission lane identifying unit 31 activates a single transmitter among a plurality of transmitters. That is, the transmission lane identifying unit 31 transmits a data block to the reception side by activating only a single optical lane, and identifies a physical lane or a physical path corresponding to a transmission order by verifying a lane identification response message from the reception side. Here, the transmission lane identifying unit 31 may generate the lane identification request message to be greater than or equal to the number of virtual lanes, and may transmit the generated lane identification request messages to a receiver through the activated transmitter. Here, the lane identification information includes lane identification information indicating an order in which data is distributed and thereby is transmitted.

According to an exemplary embodiment, when information about the changed number of lanes is received from an upper layer, the transmission lane adjusting unit 32 transmits, to the reception side through a currently available physical transmission lane, a lane adjustment request message including lane information for lane modification. When a lane adjustment response message is received from the reception side, the transmission lane adjusting unit 32 changes the number of lanes of the physical transmission lane to be used for data transmission. The transmission lane adjusting unit 32 transmits, to the PHY layer, a control signal for switching on or off a device such as an I/O port, an optical device, and the like present in a transmission and reception path of a lane.

The transmission rate control unit 33 transmits lossless data through the physical transmission lane in which the number of lanes is changed. An operation of the transmission rate control unit 33 will be described in detail below.

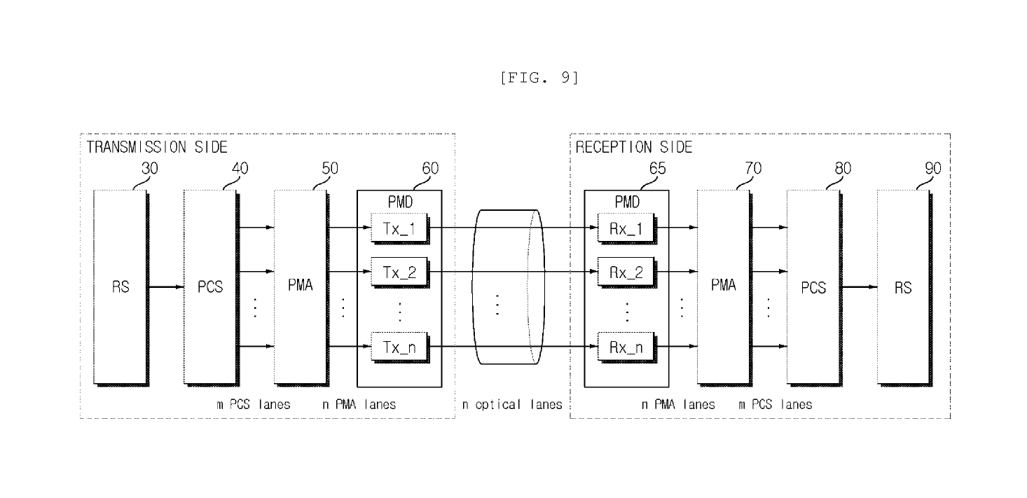

FIG. 11 is a block diagram illustrating a configuration of the RS 90 of an Ethernet apparatus of a reception side according to another exemplary embodiment of the present invention. The RS 90 includes a transmission lane identification response unit 91, a reception lane adjusting unit 92, and a transmission rate control unit 93.

The transmission lane identification response unit 91 extracts or processes lane identification information received through a plurality of receivers, and transmits the extracted or processed lane identification information to a transmission side using a lane identification response message. According to an exemplary embodiment, the transmission lane identification response unit 91 receives, from the transmission side through the plurality of receivers, a lane identification request message that includes lane identification information indicating an order in which data is distributed and thereby is transmitted. The transmission lane identification response unit 91 extracts or processes the lane identification information from the received lane identification request message, and transmits, to the transmission side, a lane identification response message that includes the lane identification information.

The reception lane adjusting unit 92 changes the number of lanes of a reception lane by obtaining modified lane information. According to an exemplary embodiment, the reception lane adjusting unit 92 receives, from the transmission side, a lane adjustment request message including information about the changed number of lanes and thereby changes the number of lanes to be used for data reception. The reception lane adjusting unit 92 transmits, to the transmission side, the lane adjustment response message indicating that changing of the number of lanes is completed.

The transmission rate control unit 93 receives lossless data by controlling a transmission rate of data received through the reception lane in which the number of lanes is changed. An operation of the transmission rate control unit 93 will be described in detail below.

Referring again to FIG. 10, the transmission rate control unit 33 inserts an idle block at a data position corresponding to a deactivated lane using a corresponding relationship identified by the transmission lane identifying unit 31, and transfers, to the PCS 40, data in which the idle block is inserted. Here, the idle block may be a non-functional block in a predetermined form.

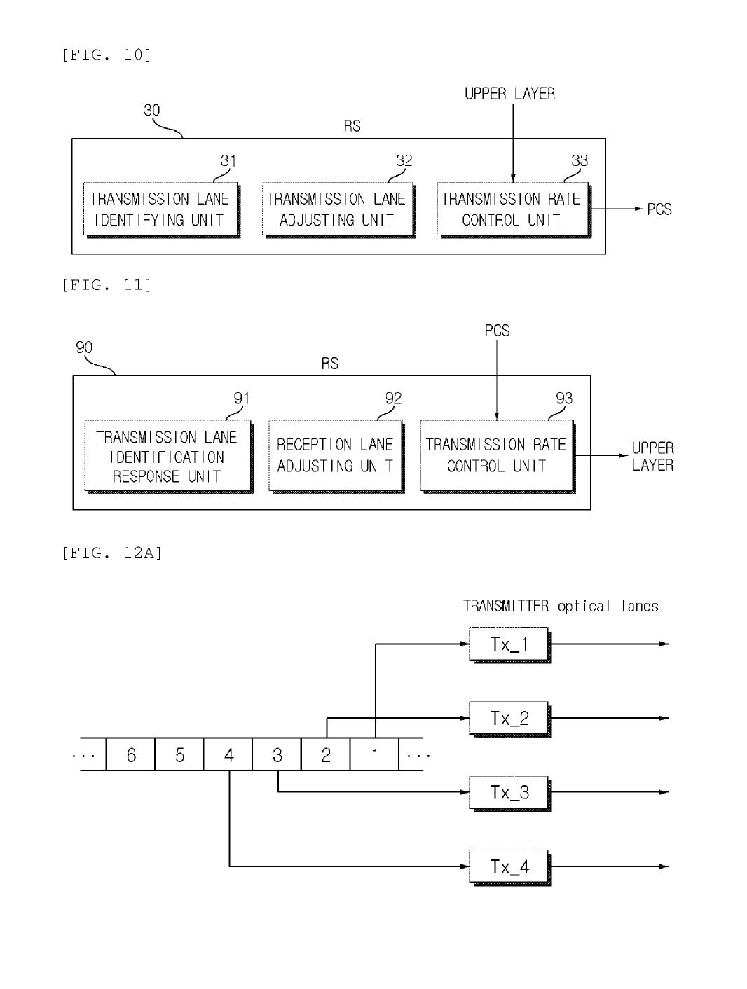

FIGS. 12A and 12B are reference diagrams to describe an operation of the transmission rate control unit 33. For example, let us assume that when the number of physical transmission lanes is four, a corresponding relationship between a data transmission order and a physical transmission lane is as shown in FIG. 12A. That is, FIG. 12A shows a case in which data is sequentially transmitted to lanes corresponding to transmitters Tx_{—}1, Tx_{—}2, Tx_{—}3, and Tx_{—}4, in a transmission order. In this case, when information about the number of operable lanes indicates “3”, and a lane corresponding to the transmitter Tx_{—}3 is deactivated as a result of transmission lane adjustment, the transmission rate control unit 33 inserts an idle block at a data position corresponding to the transmitter Tx_{—}3 as shown in FIG. 12B.

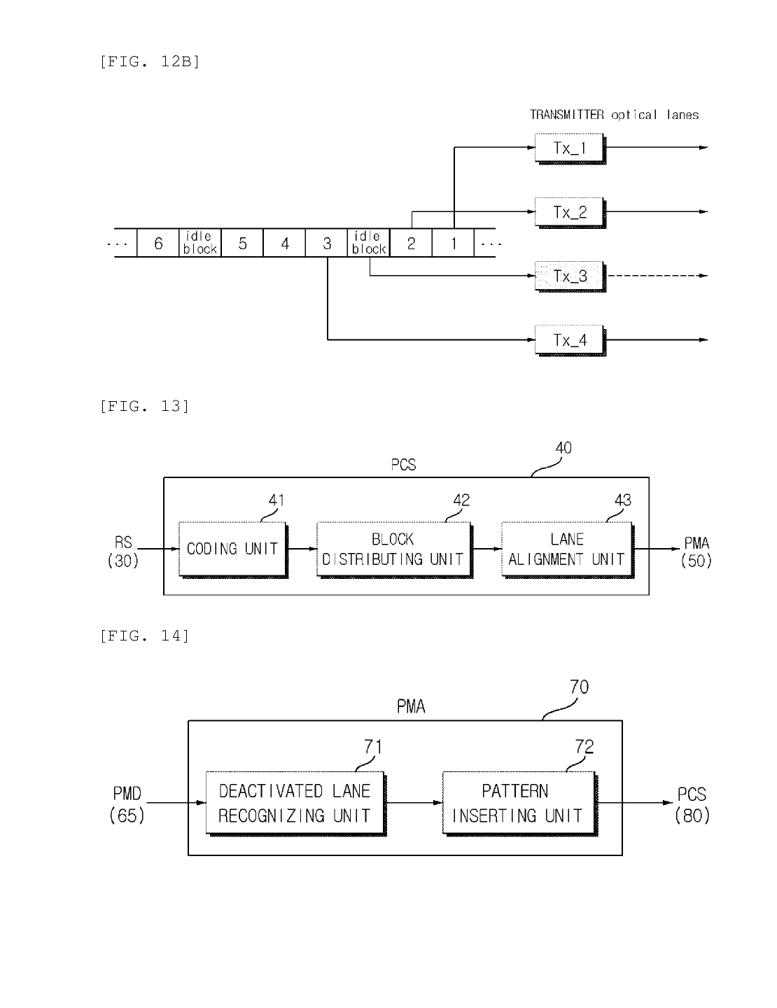

FIG. 13 is a block diagram illustrating a configuration of a PCS 40 of an Ethernet apparatus of a transmission side according to another exemplary embodiment of the present invention. The PCS 40 includes a coding unit 41, a block distributing unit 42, and a lane alignment unit 43.

The coding unit 41 generates a data block by receiving data from an RS 30, and by performing block coding of the received data. For example, the coding unit 41 may include an encoder to generate 64 bits as a 66-bit code block, a scrambler to perform scrambling for orthogonality in order to decrease a voltage recognition error of bitstreams, and the like. As described above, an idle block is included in data received from the RS 30 and thus, the idle block is also generated as a code block and scrambled.

The block distributing unit 42 receives a data block from the coding unit 41. The block distributing unit 42 distributes the received data block to each PCS lane. For example, the block distributing unit 42 may distribute the data block to each PCS lane using a round robin scheme.

The lane alignment unit 43 aligns a plurality of PCS lanes to which the data block is distributed, and transfer the data block to a PMA 50. For the above operation, the lane alignment unit 43 may insert an alignment marker into each lane at predetermined intervals.

As described above, the transmission rate control unit 33 of the RS 30 inserts an idle block at a data position corresponding to a deactivated lane based on a corresponding relationship between a data transmission order and a physical transmission lane and thus, a data block is transferred to an activated lane and the idle block is transferred to the deactivated lane. Therefore, the data block is transferred to the reception side through an activated transmitter and the idle block is not transferred to the reception side. Accordingly, all the data is transmitted without data loss.

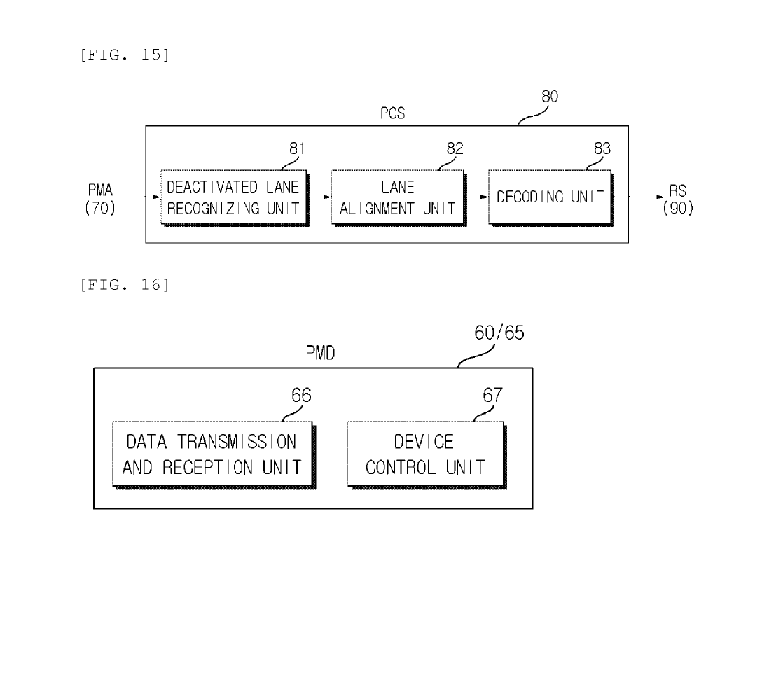

FIG. 14 is a block diagram illustrating a configuration of a PMA 70 of an Ethernet apparatus of a reception side according to another exemplary embodiment of the present invention. The PMA 70 includes a deactivated lane recognizing unit 71 and a pattern inserting unit 72.

The deactivated lane recognizing unit 71 recognizes a deactivated state of a lane. According to an exemplary embodiment, the deactivated lane recognizing unit 71 may recognize a deactivated state of some lanes by receiving deactivated lane information from a PCS 80 or a PMD 65. The pattern inserting unit 72 inserts a predetermined pattern into a PMA lane corresponding to the deactivated lane. According to an exemplary embodiment, the pattern inserting unit 72 may insert an alignment marker at an alignment interval and insert a pattern indicating an idle block at an interval excluding the alignment interval, or may insert a predetermined pattern indicating a deactivated lane state regardless of the alignment interval. The predetermined pattern may be predefined. The PMA 70 performs bit-de-multiplexing of the received data and the inserted predetermined pattern and thereby transmits the bit-de-multiplexed data and pattern to the PCS 80 through the PCS lane.

According to another exemplary embodiment, the PMD 65 may also insert, into the PMA lane corresponding to the deactivated lane, the predetermined pattern indicating the deactivated lane state. In this case, without inserting the pattern, the PMA 70 may de-multiplex the received data and thereby transmit the de-multiplexed data to the PCS 80 through the PCS lane. When an I/O port and an optical device corresponding to the deactivated lane are switched off and thereby a signal is not input, the pattern may not be inserted and the received data may be de-multiplexed.

FIG. 15 is a block diagram illustrating a configuration of the PCS 80 of an Ethernet apparatus of a reception side according to another exemplary embodiment of the present invention. The PCS 80 includes a deactivated lane recognizing unit 81, a lane alignment unit 82, and a decoding unit 83. The PCS 80 needs to provide functions such as alignment, descrambling, decoding, and the like, based on the number of reception lanes and an adjusted transmission rate in a low power mode using a portion of lanes.

The deactivated lane recognizing unit 81 recognizes a deactivated state of a lane. The deactivated lane recognizing unit 81 may recognize a deactivated lane based on deactivated lane information received from an RS 90, or may recognize the deactivated lane through a predetermined pattern received from a PMA 70, as described above.

The lane alignment unit 82 receives a data block from the PMA 70 through a plurality of lanes. The lane alignment unit 82 aligns each of the plurality of lanes. Here, the lane alignment unit 82 aligns a PCS lane corresponding to an activated lane using an alignment marker and then removes the alignment marker. Depending on exemplary embodiments, when the PMA 70 inserts the alignment marker into a PMA lane corresponding to a deactivated lane, the lane alignment unit 82 inserts an idle block into a PCS lane corresponding to the deactivated lane, aligns the lane using the alignment marker, and then removes the alignment marker. Depending on exemplary embodiments, when the PMA 70 inserts, into the PMA lane, a predetermined pattern that indicates a deactivated lane state regardless of an alignment interval, the lane alignment unit 82 inserts the idle block into the PCS lane corresponding to the deactivated lane and aligns the lane.

The decoding unit 83 descrambles and decodes the data block through the aligned lane. Here, in the case of descrambling, the decoding unit 83 may not perform descrambling with respect to the idle block that is inserted by the lane alignment unit 82. The decoded data may be transmitted to the RS 90 through a media independent interface (MII).

Referring again to FIG. 11, the transmission rate control unit 93 receives the decoded data from the PCS 80. The data received from the PCS 80 includes the decoded idle block. The transmission rate control unit 93 stores, in a queue, data excluding the idle block and removes the idle block. As described above, a transmission rate of the received data is controlled by receiving, from the PCS 80, the data in which the idle block is inserted and by removing the idle block.

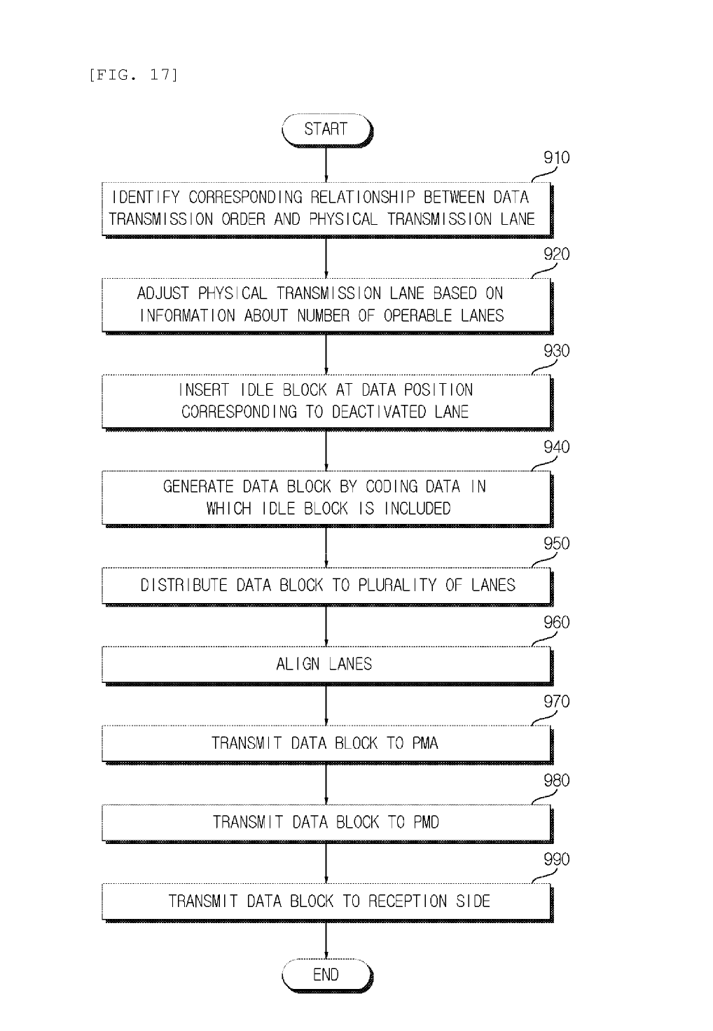

FIG. 16 is a block diagram illustrating a configuration of a PMD 60 of an Ethernet apparatus of a transmission side and a PMD 65 of an Ethernet apparatus of a reception side according to another exemplary embodiment of the present invention. Each of the PMDs 60 and 65 includes a data transmission and reception unit 66 and a device control unit 67. Each of the PMDs 60 and 65 provides a function of individually switching on or off a device and a port corresponding to each physical lane that includes an electrical lane and an optical lane.

The data transmission and reception unit 66 corresponds to the transmitters (Tx_{—}1, Tx_{—}2, . . . , Tx_n) or the receivers (Rx_{—}1, Rx_{—}2, . . . , Rx_n) of FIG. 9. The device control unit 67 functions to switch on or off a device such as a port, a transceiver, an optical device, and the like corresponding to each lane.

Each of the PMDs 60 and 65 perform data transmission and reception through the entire lanes or the predetermined number of lanes in an initial stage. When each of the PMDs 60 and 65 is shifted to a low power mode in response to a signal or a command of an upper layer, each of the PMDs 60 and 65 performs data transmission and reception through a portion of activated lanes. For the above operation, the device control unit 67 switches on a device such as a port, a transceiver, an optical device, and the like corresponding to an activated lane, and switches off a device such as a port, a transceiver, an optical device, and the like corresponding to a deactivated lane.

When data transmission and reception is performed through a portion of lanes in the low power mode, each of the PMDs 60 and 65 may provide a separate error detection function in the low power mode in order to prevent the data transmission and reception from being determined as an error of a lane or a link.

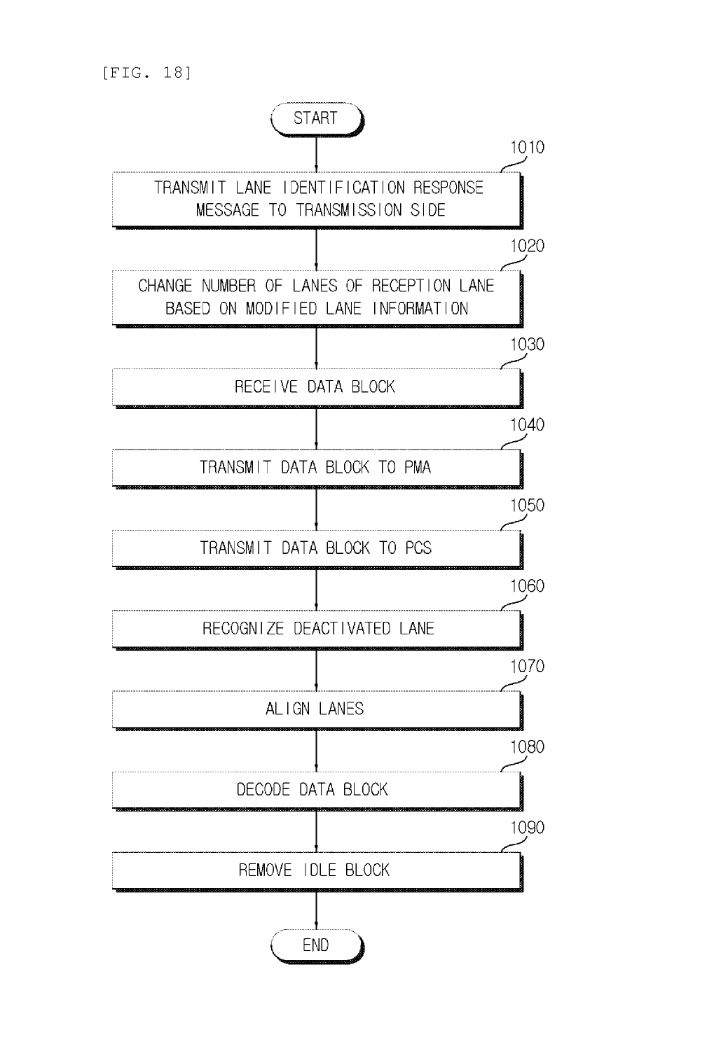

FIG. 17 is a flowchart illustrating a lane operating method of an Ethernet apparatus of a transmission side according to another exemplary embodiment of the present invention. The lane operating method according to the present exemplary embodiment may include operations that are processed in the aforementioned Ethernet apparatus of the transmission side. Accordingly, even though a description is omitted in the following description, the description made above with reference to the Ethernet apparatus of the transmission side is applied to the lane operating method according to the present exemplary embodiment.

In operation 910, the RS 30 identifies a corresponding relationship between a data transmission order and a physical transmission lane by activating a transmitter and by verifying data to be transmitted through the activated transmitter.

In operation 920, the RS 30 receives information about the number of operable lanes from an upper layer, and adjusts a physical transmission lane based on information about the number of lanes.

In operation 930, to adjust a transmission rate, the RS 30 inserts an idle block at a data position corresponding to a deactivated lane according to adjustment of the physical transmission lane. The RS 10 transmits, to the PCS 40, data that includes the idle block.

In operation 940, the PCS 40 generates a data block by performing block coding of data that is received from the RS 30 and in which the idle block is included.

In operation 950, the PCS 40 distributes the generated data block to each PCS lane.

In operation 960, the PCS 40 aligns a plurality of PCS lanes to which the data block is distributed.

In operation 970, the PCS 40 transmits the data block to the PMA 50 through the plurality of PCS lanes.

In operation 980, the PMA 50 performs bit-multiplexing of the data block that is received from the PCS 40 and thereby, transmits the bit-multiplexed data block to the PMD 60 through the plurality of PMA lanes. Due to the idle block inserted by the RS 30 in operation 930, the idle block is assigned with respect to a portion of deactivated lanes and thus, actual data is transmitted to the PMD 60 without data loss.

In operation 990, the PMD 60 transmits, to the reception side through the optical lane using a plurality of transmitters, the data block that is received from the PMA 50. Alternatively, due to the idle block inserted by the RS 30 in operation 930, the idle block is assigned with respect to a portion of deactivated transmitters or lanes and thus, actual data is transmitted to the reception side without data loss.

FIG. 18 is a flowchart illustrating a lane operating method of an Ethernet apparatus of a reception side according to another exemplary embodiment of the present invention. The lane operating method according to the present exemplary embodiment includes operations that are processed in the aforementioned Ethernet apparatus of the reception side. Accordingly, even though a description is omitted in the following description, the description made above with reference to the Ethernet apparatus of the reception side is applied to the lane operating method according to the present exemplary embodiment.

In operation 1010, the RS 90 extracts or processes lane identification information that is received through a plurality of receivers, and transmits the extracted or processed lane identification information to a transmission side using a lane identification response message.

In operation 1020, the RS 90 changes the number of lanes of a reception lane based on modified lane information.

In operation 1030, the PMD 65 receives a data block through the modified reception lane. During the above process, the data block is received through an activated optical lane or receiver, and the data block is not received through a deactivated optical lane or receiver.

In operation 1040, the PMD 65 performs optic-to-electric conversion of the received data block and thereby transmits the data block to the PMA 70.

In operation 1050, the PMA 70 performs bit-de-multiplexing of the data block that is received from the PMD 65 and transmits the bit-de-multiplexed data block to the PCS 80. During the above process, depending on exemplary embodiments, the PMA 70 recognizes a deactivated state of a lane, inserts a predetermined pattern into a PMA lane corresponding to a deactivated lane, and performs bit-de-multiplexing of the received data block and the predetermined pattern and thereby transmits the bit-de-multiplexed data block and pattern to the PCS 80 through a PCS lane.

In operation 1060, the PCS 80 recognizes the deactivated state of the lane.

In operation 1070, the PCS 80 receives the data block through the plurality of lanes and aligns each of the plurality of lanes. During the above process, the PCS 80 aligns the plurality of lanes by inserting an idle block into the deactivated lane.

In operation 1080, the PCS 80 decodes the data block through the aligned lane. During the above process, the idle block is also decoded. The PCS 80 transmits the decoded data block and idle block to the RS 90.

In operation 1090, the RS 90 stores, in a queue, data excluding the idle block from the decoded data that is received from the PCS 80, and removes the idle block.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. An Ethernet apparatus having a plurality of lanes, the apparatus comprising:
a transmission lane identifying unit to identify a physical transmission lane according to a data transmission order by activating a transmitter, and by verifying data to be transmitted through the activated transmitter; and
a transmission lane adjusting unit to adjust the physical transmission lane using information about the number of operable lanes, and to transmit data through the adjusted physical transmission lane when the physical transmission lane is identified by the transmission lane identifying unit.

2. The apparatus of claim 1, wherein:
the transmission lane identifying unit activates a single transmitter among a plurality of transmitters, and generates a lane identification request message to be greater than or equal to the number of virtual lanes, and transmits the lane identification request message to a reception end through the activated transmitter, and the lane identification request message includes lane identification information indicating an order in which data is distributed and thereby is transmitted, and
when a lane identification response message including the lane identification information is received from the reception end by activating deactivated transmitters among the plurality of transmitters, the transmission lane identifying unit identifies, from the received lane identification response message, identification information for adjusting each transmitter or physical transmission lane.

3. The apparatus of claim 2, wherein a lane identification message including the lane identification request message and the lane identification response message has a data structure including a field for identifying whether a corresponding message is the lane identification request message or the lane identification response message and a field including lane identification information that indicates an order in which data is distributed and thereby is transmitted.

4. The apparatus of claim 1, wherein:
when information about the number of operable lanes is received from an upper layer, the transmission lane adjusting unit transmits, to a reception end through a currently available physical transmission lane, a lane adjustment request message including lane adjustment information for lane modification, and
when a lane adjustment response message is received from the reception end, the transmission lane adjusting unit changes the number of lanes of the physical transmission lane to be used for data transmission, and transmits lossless data through the physical transmission lane in which the number of lanes is changed.

5. The apparatus of claim 4, wherein a lane adjustment message including the lane adjustment request message and the lane adjustment response message has a data structure including a field for identifying whether a corresponding message is the lane adjustment request message or the lane adjustment response message and a field including information about the number of lanes to be used for data transmission.

6. The apparatus of claim 4, wherein a lane adjustment message including the lane adjustment request message and the lane adjustment response message has a data structure including a field for identifying whether a corresponding message is the lane adjustment request message or the lane adjustment response message, a field including information about the changed number of lanes, and a field including information about increase or decrease in the number of lanes.

7. The apparatus of claim 1, wherein:
the transmission lane identifying unit and the transmission lane adjusting unit perform lane identification and lane adjustment using a lane operation message including a transmission lane identification message, a transmission lane adjustment message, and a transmission lane error message, and
the lane operation message has a data structure including a field indicating a type of the lane operation message, a field indicating whether a corresponding message is a request message or a response message, a field including information about increase or decrease in the number of lanes, and a field including an identification number based on the type of the lane operation message, information about the number of lanes, or information about a state of each lane.

8. An Ethernet apparatus having a plurality of lanes, the apparatus comprising:
a transmission lane identification response unit to generate a response message by extracting or processing lane identification information that is received through a plurality of receivers; and
a reception lane adjusting unit to change the number of lanes of a reception lane by obtaining modified lane information, and to receive lossless data through the reception lane in which the number of lanes is changed.

9. The apparatus of claim 8, wherein the transmission lane identification response unit receives, from a transmission end through the plurality of receivers, a lane identification request message including lane identification information indicating an order in which data is distributed and thereby is transmitted, processes the lane identification information from the received lane identification request message, and transmits, to the transmission end, a lane identification response message including the processed lane identification information.

10. The apparatus of claim 8, wherein the reception lane adjusting unit receives, from a transmission end, a lane adjustment request message including information about the changed number of lanes, changes the number of lanes to be used for data reception, and transmits, to the transmission end, a lane adjustment response message indicating that changing of the number of lanes is completed.

11. An Ethernet apparatus having a plurality of lanes, the apparatus comprising:
a transmission lane identifying unit to identify a corresponding relationship between a data transmission order and a physical transmission lane;
a transmission lane adjusting unit to adjust the physical transmission lane based on information about the number of operable lanes; and
a transmission rate control unit to insert an idle block into a data position corresponding to a deactivated lane according to adjustment of the physical transmission lane using the identified corresponding relationship.

12. The apparatus of claim 11, wherein the transmission lane identifying unit, the transmission lane adjusting unit, and the transmission rate control unit are formed within a reconciliation sublayer (RS).

13. The apparatus of claim 11, further comprising:
a coding unit to generating a data block by coding data including the idle block;
a block distributing unit to distribute the generated data block to a plurality of lanes; and
a lane alignment unit to align the plurality of lanes to which the data block is distributed.

14. The apparatus of claim 13, wherein the coding unit, the block distributing unit, and the lane alignment unit are formed within a physical coding sublayer (PCS).

15. The apparatus of claim 11, further comprising:
a device control unit to switch off a device and a port corresponding to the deactivated lane according to adjustment of the physical transmission lane.

16. An Ethernet apparatus having a plurality of lanes, the apparatus comprising:
a deactivated lane recognizing unit to recognize a deactivated lane in a physical transmission lane;
a lane alignment unit to align a plurality of lanes by inserting an idle block into the deactivated lane; and
a decoding unit to decode a data block and the idle block through the aligned lanes.

17. The apparatus of claim 16, wherein the deactivated lane recognizing unit, the lane alignment unit, and the decoding unit are formed within a PCS.

18. The apparatus of claim 16, further comprising:
a transmission rate control unit to remove the idle block included in data that is received from the decoding unit.

19. The apparatus of claim 18, further comprising:
a reception lane adjusting unit to change the number of reception lanes by obtaining modified lane information.

20. The apparatus of claim 19, wherein the transmission rate control unit and the reception lane adjusting unit are formed within an RS.
